(19) United States
(12) Patent Application Publication
(10) Pub. No.: US 2025/0064026 A1
(43) Pub. Date: Feb. 27, 2025

(54) POULTRY FEEDER AND DRINKER

(71) Applicant: COMPANA PET BRANDS LLC, Chesterfield, MO (US)

(72) Inventor: Zhengguo Wang, Shanghai (CN)

(21) Appl. No.: 18/397,268

(22) Filed: Dec. 27, 2023

(30) Foreign Application Priority Data
Aug. 21, 2023 (CN) 202322250914.0
Aug. 21, 2023 (CN) 202330534261.1
Aug. 21, 2023 (CN) 202330534309.9

(51) Int. Cl. A01K 39/012; A01K 39/02; B65D 25/22; B65D 25/28; B65D 25/38

(52) U.S. Cl. CPC A01K 39/012; A01K 39/02; B65D 25/22; B65D 25/2858; B65D 25/38

(57) ABSTRACT

A poultry drinker or feeder includes a dish and a storage container arranged above the dish. The dish includes a bottom wall, a side wall, and a trough. The trough has a top opening and is partly enclosed by the side wall. The side wall is wavy and arranged to separate the trough into a plurality of chutes and define a gap between adjacent chutes. The poultry drinker or feeder can cause the poultry to automatically separate when drinking or eating, maintain a distance between each other, and eat calmly.

### CROSS-REFERENCE TO RELATED APPLICATIONS

The present application claims the benefit of priority to China Invention patent application No. 202322250914.0, filed Aug. 21, 2023, China Design Patent Application Serial No. 202330534309.9, filed Aug. 21, 2023, and China Design Patent Application Serial No. 202330534261.1, filed Aug. 21, 2023, the disclosures of which are hereby incorporated by reference in their entirety.

### TECHNICAL FIELD

The field of the disclosure relates generally to animal feeding equipment, and more specifically, to feeders and drinkers for ducks or other poultry.

### BACKGROUND

In the process of large-scale poultry breeding (e.g. chickens, ducks, geese, etc.), poultry feeders or drinkers are generally used to facilitate feeding and hydrating poultry.

For example, poultry feeders or drinkers may include a main structure having a dish and a barrel body. The barrel body is positioned on top of the dish. The dish is generally a disc-shaped structure, and the barrel body is generally a cylindrical structure. The barrel is used to hold water or feed, which is allowed to flow into the dish under its own gravity for poultry drinking or eating.

When drinking or eating from the devices, the poultry will line up around the dish of the poultry feeder or drinker. Because the dish is a disc-shaped structure, poultry are easily crowded together when drinking/eating, compete with each other for food, and may fight or splash food out from the dish. Therefore, the poultry drinkers or feeders not only can cause the waste of food, but also may make some weak poultry be injured. In addition, the poultry drinkers or feeders may not provide nutrition to all poultry, and may not be conducive to the healthy growth of poultry because the poultry are crowded and have to compete for food.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a poultry drinker or feeder includes a dish including a bottom wall and a side wall, a storage container arranged above the dish, and a trough defined by the side wall of the dish. The trough has an open top. The side wall is a wavy shape and divides the trough into a plurality of chutes. The side wall provides gaps between adjacent chutes of the plurality of chutes.

In another aspect, a dish for a poultry drinker or feeder includes a bottom wall having an edge. The bottom wall is arranged to receive a storage container such that the storage container is above the dish. The dish also includes a side wall, and a trough defined by the side wall of the dish and the bottom wall of the dish. The trough has an open top. The side wall is in a wavy shape and divides the trough into a plurality of chutes. The side wall provide gaps between adjacent chutes of the plurality of chutes.

In yet another aspect, a method of assembling a poultry drinker or feeder includes connecting a dish to a storage container. The dish includes a bottom wall having an edge and a side wall extending along the edge of the bottom wall. The storage container is above the dish. The method also includes arranging the dish to define a trough formed by the side wall of the dish. The trough has an open top. The side wall is a wavy shape and divides the trough into a plurality of chutes. The side wall provides gaps between adjacent chutes of the plurality of chutes.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of an example poultry feeder, the poultry feeder including a storage compartment and a dish.

FIG. 2 is a schematic cross-section of the poultry feeder shown in FIG. 1.

FIG. 3A is a perspective view of the structure of the dish of the poultry feeder shown in FIG. 1.

FIG. 3B is an enlarged view of a portion of the dish shown in FIG. 3A.

FIG. 4 is a schematic diagram of the storage compartment of the poultry feeder shown in FIG. 1.

FIG. 5 is a perspective view of another example of a poultry feeder, the poultry feeder including a storage compartment and a disc.

FIG. 6 is a schematic cross-section of the poultry feeder shown in FIG. 5.

FIG. 7 is a perspective view of the dish of the poultry feeder shown in FIG. 5.

FIG. 8 is a perspective view of the storage compartment of the poultry feeder shown in FIG. 5.

Corresponding reference characters indicate corresponding parts throughout the several views of the drawings. Although specific features of various examples may be shown in some drawings and not in others, this is for convenience only. Any feature of any drawing may be reference or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The terms “first”, “second”, “third”, “in the description and claims is used to distinguish similar objects, and does not have to be used to describe a particular order.

As used herein, orientation words (e.g., upper, lower, left, right, front, rear, top, bottom, etc.) are defined by the position of the structures in the drawings and the positions of components relative to each other.

An object of the disclosure is to provide a poultry drinker or feeder, which can cause poultry to automatically separate from each other when drinking water or eating food from the poultry drinker or feeder, maintain a certain distance from other poultry, and eat calmly. In addition, the poultry drinker or feeder can reduce the waste of feed and facilitate the health of poultry by providing adequate nutrition and hydration for the poultry.

The disclosure provides a poultry drinker or feeder including a dish and a storage container arranged above the dish. The dish generally includes a bottom wall, a side wall, and a trough with a top opening enclosed by the side wall and extending around the bottom wall. The side wall extends along the edge of the bottom wall. At least a portion of the side wall is wavy and arranged to separate the trough into a plurality of chutes. In addition, the side wall is shaped to provide a gap between adjacent chutes.

In an example, the side wall protrudes outward at positions corresponding to each of the chutes, or the side wall protrudes outward at positions corresponding to the gaps between the chutes.

In an example, the side wall is slanted outward around the bottom wall and between the bottom wall of the dish and the top of the dish.

In an example, a plurality of chutes are uniformly arranged along the circumferential direction of the dish.

In an example, the gap between the chutes has a height that is equal to a height of the storage trough.

In an example, the dish is provided with a circular table-shaped boss that protrudes upwards from the bottom plate. The bottom of the storage container is connected to the boss. The storage trough is formed between the side wall and the boss. The top of the boss is provided with a slot and at least one connecting groove. The bottom end of the storage container is inserted into the slot, and the inner cavity of the storage container is communicated with each of the storage grooves through a connecting groove.

In an example, the trough is provided with a conical protrusion that protrudes upwards. The bottom of the storage container is connected with the bottom wall and covers the protruding portion. The storage groove is formed between the side wall and the storage container. The bottom of the storage container is provided with a plurality of notches. The notches are arranged along the circumferential interval of the storage container, and the inner cavity of the storage container is communicated with each of the storage grooves through the plurality of notches.

In an example, the bottom of the storage container is provided with a plurality of baffles. The baffles are arranged at intervals along the circumference of the storage container. The baffles are positioned between the side wall and the storage container, and one end of each baffle close to the side wall is arranged to correspond with a gap between the chutes.

In an example, the poultry feeder further includes a top cover. The top of the storage container has a top opening. The top cover is positioned on the storage container to cover the top opening.

In an example, the dish is provided with a first clamping part, and the bottom of the storage barrel is provided with a second clamping part. The first clamping part is provided with a clamping groove. The clamping groove is arranged along the circumferential extension of the dish and is open to a center of the dish along a portion of the circumference of the dish. The clamping groove has one end that is open and an opposite end that is closed.

The disclosure discloses a poultry drinker or feeder that includes a dish having a side wall defining a trough. The side wall of the dish is a wavy structure separating the trough into a plurality of chutes. In addition, the side wall provides a gap between adjacent chutes of chutes. For example, at a location corresponding to the gap the width of the trough is smaller, or the trough does not exist such that the poultry cannot easily drink or eat at the gaps. As a result, the poultry can drink or eat at the chutes which are spaced apart, and the poultry will not drink or cat at the gap positions. Therefore, the poultry feeder causes poultry to automatically separate when drinking or eating and maintain a certain distance according to the distribution structure of the multiple chutes. In addition, the poultry will eat calmly, and no longer grab food or fight with each other. Further, the poultry feeder may reduce waste caused by feed or liquid splashing, and at the same time reduce the possibility of poultry fighting or being injured and ensure the health of the poultry.

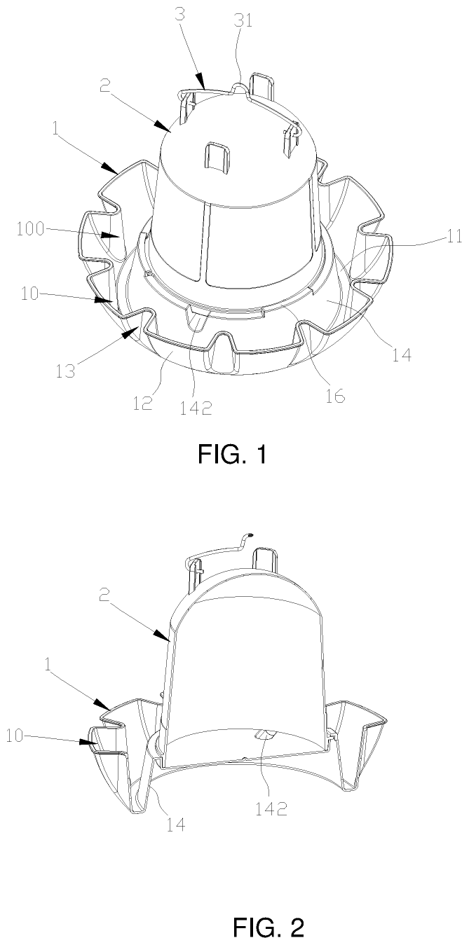

As shown in FIGS. 1-4, an embodiment of the disclosure provides a poultry drinker or feeder for providing liquids or food to poultry (such as chickens, ducks, geese, etc.) or other poultry (such as birds). The poultry drinker or feeder comprises a dish 1 and a storage container 2 arranged above the dish 1. The dish 1 is a disc-shaped or bowl-shaped structure. The dish 1 includes a bottom wall 11, a side wall 12 and a trough 100. The side wall 12 extends upward from an edge of the bottom wall 11 and at least an upper edge of the side wall 12 is wavy. The trough 100 has a top opening that is defined by upper edge of the side wall 12 and that extends around a circumference of the bottom wall 11. The side wall 12 is wavy and arranged to separate the trough 100 into a plurality of chutes 10. In the example, side wall 12 defines a gap 13 between adjacent chutes 10. For example, the side wall 12 is arranged to alternately define the chutes 10 and the gaps 13 around the circumference of the bottom wall 11 of the dish 1.

The storage container 2 is roughly a cylindrical or round-table structure, and the storage container 2 is used for storing water or food. The bottom of the storage container 2 is connected with the dish 1, and the inner cavity of the storage container 2 is communicated with each chute 10 of the trough 100, so that the water or feed stored in the storage container 2 can flow into each chute 10 of the trough 100.

For example, the side wall 12 is a wavy shape and separates the trough 100 into a plurality of chutes 10. Because the side wall 12 of the dish 1 is a wavy structure, the side wall 12 defines a gap 13 between adjacent chutes 10. The side wall 12 and the gaps 13 cause the water or feed to be concentrated in each chute 10, and prevent the poultry from easily drinking or eating at the position of the gaps 13. For example, the storage space of the dish 1 at the gaps 13 is small or does not exist. The poultry can drink or eat at the chute 10 positions separately, and will not drink/eat at the positions of the gaps 13. Therefore, the poultry drinker or feeder causes the poultry eating or drinking from the poultry drinker or feeder to automatically separate and maintain a distance from each other according to the distribution of the plurality of chutes 10 when drinking or eating. The poultry may eat more calmly, and no longer grab food or fight with each other, thereby reducing the waste caused by feed splashing, and at the same time reducing the possibility of poultry fighting and injury, and facilitating the health of the poultry. Moreover, the bottom of the storage container 2 is connected with the dish 1, and the inner cavity of the storage container 2 is communicated with each chute 10, so that the water or feed stored in the storage container 2 can flow to each chute 10 equally, and each chute 10 is guaranteed to have sufficient water or feed.

In an example, the side wall 12 of the dish 1 forms a plurality of the gaps 13. For example, the side wall 12 may define four to eighteen of the gaps 13 separating four to eighteen of the chutes 10 along the circumference of the dish 1. The number and size of the gaps 13 and the chutes 10 can be set according to the size of the dish 1 and the body size of the poultry. In other embodiments, the poultry drinker or feeder may include 1, 2, 3, or more than 18 of the gaps 13 and/or the chutes 10.

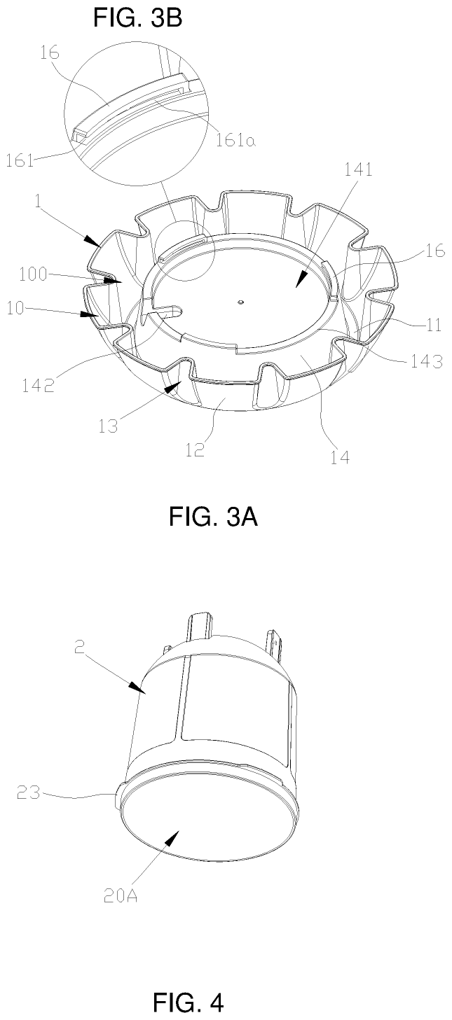

As shown in FIG. 1 and FIG. 3A, in an example, the side wall 12 is convex outward at positions or locations corresponding to the chutes 10 (i.e., the side wall 12 protrudes outward at the position of each chute 10 compared to the position of the corresponding gap 13). Alternatively, the position of the side wall 12 is convex outward at positions corresponding to the gaps 13 and the position of the side wall 12 corresponding to the chutes 10 is concave inward, (i.e., the position of the chute 10 corresponding to the side wall 12 is concave inward compared with the position of the corresponding gap 13). As a result, the poultry can drink water or eat at the positions of the chutes 10, and the gaps 13 separate the poultry and reduce congregating.

As shown in FIG. 1 to FIG. 3A, in an example, the gap 13 extends downwards from the top of the side wall 12 to the bottom of the side wall 12, and the height of the gap 13 is the same as that of the chute 10.

As shown in FIG. 1 to FIG. 3A, in an example, the side wall 12 is inclined outward along the extension from the bottom wall 11 to the top of the side wall 12 at positions corresponding to the chutes 10, and the outer diameter of the side wall 12 is gradually reduced from top to bottom (i.e., the dish 1 is a bowl-shaped structure). As a result, water or feed is concentrated and gathered in the upper part of each chute 10. Therefore, the upper part of the chutes 10 provide an increased opening to facilitate poultry drinking water or feed. For example, the chutes 10 are convenient for poultry to drink water or eat with a portion of their body or mouths in or at the upper position of the chute 10, especially for poultry with large beaks, such as ducks.

As shown in FIG. 1 and FIG. 3A, in an example, the plurality of chutes 10 are evenly arranged along the circumferential direction of dish 1, so that poultry can evenly stand in a circle around the dish 1 when drinking or eating. As an example, a plurality of the chutes 10 are communicated with each other, and the inner cavity of the storage container 2 is communicated with one or more of the chutes 10. In the example, the inner cavity of the storage container 2 is communicated with all the chutes 10 simultaneously because the chutes are connected. Of course, in other embodiments, the inner cavity of the storage container 2 can also be communicated with each chute 10 one by one.

As shown in FIG. 1, as an example, the bottom of the storage container 2 and the dish 1 are fixed by clamping.

As shown in FIGS. 3A, 3B, and 4, as an example, the dish 1 is provided with a first clamping portion 16. A second clamping portion 23 is arranged at the bottom of the storage container 2. The second clamping portion 23 protrudes radially along the outer side wall of the storage container 2. The first clamping portion 16 is provided with a clamping groove 161 that can be clamped and fixed with the second clamping portion 23. For example, the clamping groove 161 is arranged along the circumferential extension of dish 1. A slot 161a of the clamping groove 161 is formed in one side of the first clamping portion 16 and open to the center of dish 1 along a circumferential direction of the dish 1. The clamping groove 161 has an open end allowing insertion into the slot 161a and a closed end opposite the open end. Further, a bump (not shown) may be arranged in the groove 161 of the first clamping portion 16, and a projection bar (not shown) may be arranged on the second clamping portion 23. The bump and the projection bar are correspondingly arranged with each other to further secure the first clamping portion 16 and the second clamping portion 23, and facilitate the operator perceiving that the first clamping portion 16 and the second clamping portion 23 have been rotated in place (i.e., the rotation for securement has been completed).

During assembly, the storage container 2 is clamped and fixed with the dish 1. For example, after the storage container 2 is placed onto the dish 1, the storage container 2 is rotated so that the second clamping portion 23 on the storage container 2 is inserted into the clamping groove 161 from the open end of the clamping groove 161. The user may stop rotating when the user perceives that the projection bar of the storage container 2 rotates past the securement point of the dish 1. In the secured position, the second clamping portion 23 is against the inner wall of the closed end of the clamping groove 161. When the storage container 2 needs to be removed from the dish 1, the storage container 2 is counter-rotated and the second clamping portion 23 can be separated from the clamping groove 161.

As shown in FIG. 3A and FIG. 4, as an example, the dish 1 is provided with a plurality of the first clamping portions 16 arranged at intervals along the circumference of the dish 1. The bottom of the storage container 2 is provided with a plurality of the second clamping portions 23 arranged at intervals along the circumference of the storage container 2, and corresponding to the positions of the first clamping portions 16. For example, the plurality of second clamping portions 23 are respectively arranged for a one-to-one correspondence with the plurality of first clamping portions 16 such that each second clamping portion 23 mates with a corresponding one of the first clamping portions 16 when the storage container 2 is secured to the dish 1.

As shown in FIG. 1 to FIG. 3A, the trough 100 of the dish 1 is provided with a boss 14 that protrudes upward. The boss 14 is connected with the bottom wall 11 of dish 1. The boss 14 is a circular platform-shaped structure. The boss 14 is positioned at the middle position in the dish 1, and the trough 100 is formed between the side wall 12 and the boss 14. The bottom of the storage container 2 is connected with the boss 14, and the inner cavity of the storage container 2 is communicated with each chute 10.

As shown in FIGS. 1-4, as an example, the top of the boss 14 is provided with a recess 141 sized to receive the storage container 2, and at least one connecting groove 142. The poultry drinker or feeder includes one of the connecting grooves 142 in this embodiment, but the poultry drinker or feeder includes more than one of the connecting grooves 142 in other embodiments. The top face of the boss 14 is concave downward and the boss 14 includes a rim 143 extending around a circumference of the boss 14. The recess 141 and the connecting groove 142 are both formed at least in part by the rim 143. The connecting groove 142 is concave downward and extends laterally through the rim 143 and the top face of the boss 14.

In the example, the storage container 2 is arranged for storing and supplying the feed or liquid to the trough 100. For example, the top of the storage container 2 is sealed. The bottom of the storage container 2 has a bottom opening 20A. During assembly of the poultry drinker or feeder, the bottom end of the storage container 2 is inserted into the recess 141, so that the storage container 2 is closely connected with the boss 14. The inner cavity of the storage container 2 is communicated with each chute 10 through the connecting groove 142. The inner cavity of the storage container 2 is communicated with the recess 141 through its bottom opening 20A. The connecting groove 142 extends between and connects the recess 141 and the trough 100. The chutes 10 of the trough are connected with each other such that each chute 10 receives feed or liquid provided to the trough 100 by the connecting groove 142. For example, the trough 100 is open and fee of obstructions between the gaps 13 and the boss 14 and around the circumference of the boss 14.

Specifically, in this embodiment, there is a gap between the side wall 12 and the outer side wall of the boss 14 at locations corresponding to the gap 13 positions, so that the plurality of chutes 10 are communicated with each other through the gaps between the side wall 12 and the boss 14, and the inner cavity of the storage container 2 is connected with all the chutes 10 simultaneously. Because the inner cavity of the storage container 2 in the above-mentioned structure is communicated with the chutes 10 through the connecting groove 142, and the size of the connecting groove 142 is generally small, the poultry drinker or feeder in this embodiment may be more suitable for feeding the poultry with water (the feed is not convenient to enter each chute 10 through the connecting groove 142), that is, the poultry drinker or feeder is a poultry drinker, the storage container 2 is used for water storage, and the water stored in the storage container 2 can enter each chute 10 through the bottom opening 20A, the recess 141 and the connecting groove 142.

As shown in FIG. 3A, as an example, a plurality of the first clamping portions 16 are arranged at the top of the boss 14, and in a circle around the periphery of the recess 141. The first clamping portions 16 extend upward from the rim 143.

As shown in FIG. 1, as an example, the poultry drinker or feeder further comprises a handle 3. The handle 3 is connected with the top of the storage container 2, and the two ends of the handle 3 are hinged with the top of the storage container 2. The handle 3 can be used to carry the poultry drinker or feeder or hang it in the desired position.

As shown in FIG. 1, as an example, the middle position of handle 3 is provided with a hook portion 31 that is convenient for hanging the poultry drinker or feeder.

As an example, the handle 3 may be made of materials such as metal, plastic, wood, etc.

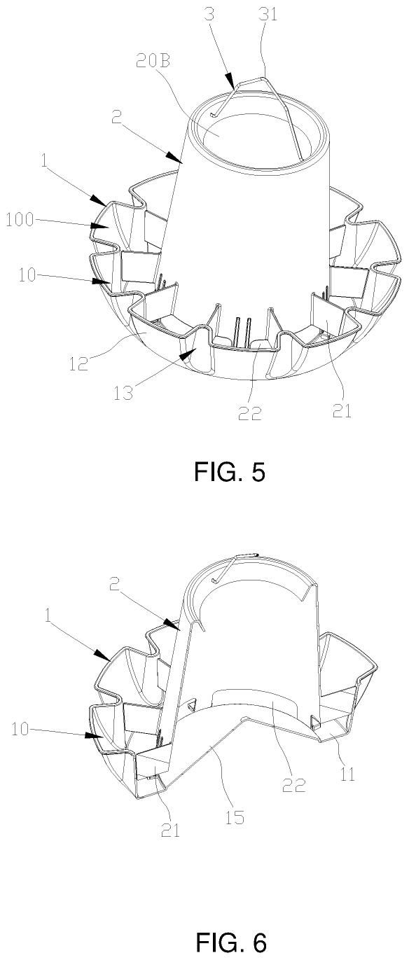

The storage container 2 may have any suitable top. As shown in FIG. 1, as an example, the top of the storage container 2 is a closed structure. Alternatively, as shown in FIG. 5, as another example, the top of the storage container 2 has a top opening 20B. The poultry drinker or feeder may include a top cover that is arranged at the top opening 20B of the storage container 2 to cover the top opening 20B of the storage container 2. The top cover facilitates the feed remaining dry and protected from the environment to prevent dampness and deterioration of the feed in the poultry drinker or feeder when the poultry drinker or feeder is placed outdoors. The top cover may be removed or omitted when the poultry drinker or feeder is placed indoors for use.

As shown in FIGS. 5-8, as another example, the dish 1 includes a conical protrusion portion 15 that is arranged in the trough 100 and extends upward from the bottom wall 11 of the dish 1. The protrusion portion 15 is connected with the bottom wall 11 of dish 1, and the protrusion portion 15 is positioned at the middle position in dish 1. To assemble the poultry drinker or feeder, the bottom of the storage container 2 is connected with the bottom wall 11 of the dish 1 such that the bottom of the storage container 2 covers the protrusion 15. The chutes 10 are formed between the side wall 12 and the storage container 2. The bottom of the storage container 2 has a bottom opening 20A, and is provided with a plurality of notches 22. The plurality of notches 22 are arranged at intervals along the circumference of the storage container 2. The inner cavity of the storage container 2 is communicated with each chute 10 through the plurality of notches 22.

The side wall 12 of the dish 1 is a wavy shape to separate the trough 100 into a plurality of chutes 10. In addition, the side wall 12 provides gaps 13 between adjacent chutes 10. The storage space of the dish 1 between the side wall 12 and the side wall of the storage container 2 at positions corresponding to the gaps 13 is small or does not exist. As a result, the poultry are not able to easily drink or eat at the gap 13 positions, and the poultry eating or drinking from the poultry drinker or feeder around the trough 100 are separated. For example, the poultry drinker or feeder facilitates poultry eating or drinking at the chutes 10 and not eating or drinking at the positions of the gaps 13. Therefore, the poultry at the poultry drinker or feeder separate from each other and maintain a distance from each other according to the distribution structure of the multiple chutes 10 when drinking or eating. The poultry may cat calmly, and no longer grab food or fight with each other, thereby reducing the waste caused by feed splashing, and reducing the possibility of poultry fighting and injury. Moreover, the bottom of the storage container 2 is connected with the dish 1, and the inner cavity of the storage container 2 is connected to each chute 10 by the notches 22 such that the water or feed stored in the storage container 2 can flow to each chute 10, and each chute 10 is guaranteed to have sufficient water or feed.

As shown in FIGS. 5-8, as an example, the bottom of the storage container 2 is provided with a plurality of baffle plates 21. The baffle plates 21 protrude outward from the side wall of the storage container 2. The baffle plates 21 can be fixed on the side wall of the storage container 2 through connection modes such as clamping or can be formed integrally with the side wall. A plurality of the baffle plates 21 are arranged at intervals along the circumference of the storage container 2. The baffle plates 21 are positioned between the side wall 12 and the storage container 2, and are arranged to align with the gaps 13. In the example, the baffle plates 21 are provided in a one-to-one ratio with the gaps 13 and each baffle plate 21 is aligned with a corresponding gap 13. One end of each baffle plate 21 is connected with the storage container 2, and the other end is against the side wall 12 of the dish 1 at the corresponding gap 13. The baffle plates 21 facilitate separating adjacent chute 10 such that each chute 10 is positioned between two adjacent baffle plates 21. As a result, feed can be better gathered in the chutes 10.

In the example, because the inner cavity of the storage container 2 is directly communicated with each chute 10 through a plurality of notches 22, the feed pellets can conveniently enter each chute 10 through a corresponding one of notches 22 and the chutes 10 do not need to be directly connected to each other. The poultry drinker or feeder in the example facilitates, in particular, feeding poultry. For example, the storage container 2 is used for storing the feed, and the feed stored in the storage container 2 can directly enter each chute 10 through the plurality of notches 22. The conical protrusion 15 is arranged on the dish 1 so that the feed in the storage container 2 can slide around along the surface of the protrusion 15 to each chute 10 under the action of gravity and facilitate poultry feeding.

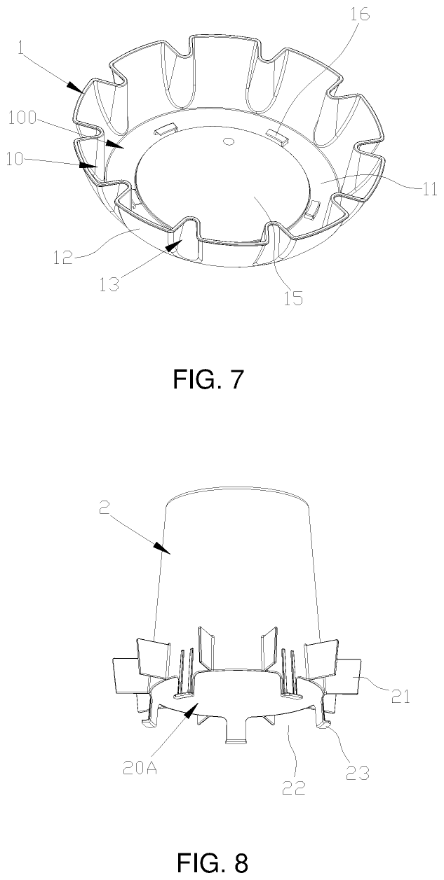

As shown in FIG. 7, as an example, a plurality of first clamping portions 16 are arranged on the bottom wall 11 of dish 1. The plurality of first clamping portions 16 are arranged in a circle around the periphery of the protrusion portion 15.

In examples of the disclosure, a poultry drinker or feeder includes a dish and a storage container arranged above the dish. The dish includes a bottom wall, a side wall, and a trough. The trough has a top opening and is partly enclosed by the side wall. The side wall is wavy and arranged to separate the trough into a plurality of chutes and define a gap between adjacent chutes. The poultry drinker or feeder can cause the poultry to automatically separate when drinking or eating, maintain a distance between each other, and eat calmly.

As used herein, an element or step recited in the singular and proceeded with the word “a” or “an” should be understood as not excluding plural elements or steps unless such exclusion is explicitly recited. Furthermore, references to “one embodiment” of the disclosure or an “example” are not intended to be interpreted as excluding the existence of additional embodiments that also incorporate the recited features. Likewise, limitations associated with “one embodiment” or “an embodiment” or “an example” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A poultry drinker or feeder, comprising:
a dish including a bottom wall and a side wall;
a storage container arranged above the dish,
a trough defined by the side wall of the dish, wherein the trough has an open top,
wherein the side wall is a wavy shape and divides the trough into a plurality of chutes, and wherein the side wall provides gaps between adjacent chutes of the plurality of chutes.

2. The poultry drinker or feeder of claim 1, wherein the side wall protrudes outward at positions corresponding to the positions of the chutes, or the side wall protrudes inward at positions corresponding to the positions of the gaps.

3. The poultry drinker or feeder of claim 1, wherein the side wall extends around the bottom wall and is inclined outward along the extension between the bottom wall of the dish and the open top of the trough.

4. The poultry drinker or feeder of claim 1, wherein the plurality of chutes are uniformly arranged along a circumference of the dish.

5. The poultry drinker or feeder of claim 1, wherein the gaps are the same height as the chutes.

6. The poultry drinker or feeder of claim 1, wherein the bottom wall of the dish is provided with a circular platform-shaped boss that protrudes upwardly and connects to a bottom of the storage container, wherein the trough is defined between the side wall and the boss, wherein a top of the boss is provided with a recess that receives the bottom of the storage container and at least one connecting groove, and wherein an inner cavity of the storage container is communicated with each storage trough through the at least one connecting groove.

7. The poultry drinker or feeder of claim 1, wherein the dish includes a conical protrusion that protrudes upwards from the bottom wall, wherein a bottom of the storage container is connected with the bottom wall and covers the conical protrusion, wherein the bottom of the storage container defines a plurality of notches arranged at intervals along a circumference of the storage container, and wherein the trough is defined between the storage container and the side wall of the dish and the an inner cavity of the storage container is communicated with the trough through the plurality of notches.

8. The poultry drinker or feeder of claim 7, wherein the bottom of the storage container includes a plurality of baffles arranged at intervals along the circumference of the storage container, wherein the plurality of baffles are positioned between the side wall and the storage container, and wherein one end of each baffle is close to the side wall at a location corresponding to a respective one of the gaps.

9. The poultry drinker or feeder of claim 7, wherein the poultry drinker or feeder further comprises a top cover defining a top opening.

10. The poultry drinker or feeder of claim 1, wherein the dish is provided with a first clamping portion, wherein a bottom of the storage container is provided with a second clamping portion, the first clamping portion is provided with a clamping groove arranged along a circumference of the dish, and wherein the clamping groove has an open end, a closed end and a notch open to a center of the dish and extending around the circumference of the dish.

11. A dish for a poultry drinker or feeder, the dish comprising:
a bottom wall having an edge, the bottom wall arranged to receive a storage container such that the storage container is above the dish;
a side wall; and
a trough defined by the side wall of the dish and the bottom wall of the dish, wherein the trough has an open top,
wherein the side wall is a wavy shape and divides the trough into a plurality of chutes, and wherein the side wall defines gaps between adjacent chutes of the plurality of chutes.

12. The dish of claim 11, wherein the side wall protrudes outward at positions corresponding to the positions of the chutes, or the side wall protrudes inward at positions corresponding to the positions of the gaps.

13. The dish of claim 11, wherein the side wall extends around the bottom wall and is inclined outward along the extension between the bottom wall of the dish and the open top of the trough.

14. The dish of claim 11, wherein the plurality of chutes are uniformly arranged along a circumference of the dish.

15. The dish of claim 11, wherein the gaps are the same height as the chutes.

16. The dish of claim 11, further comprising a circular platform-shaped boss or a conical protrusion that protrudes upwardly from the bottom wall of the dish.

17. A method of assembling a poultry drinker or feeder, the method comprising:
connecting a storage container to a dish, the dish including a bottom wall having an edge and a side wall extending along the edge of the bottom wall, the storage container is above the dish; and
arranging the dish to define a trough formed by the side wall of the dish, wherein the trough has an open top, and wherein the side wall is a wavy shape and divides the trough into a plurality of chutes, and wherein the side wall provides gaps between adjacent chutes of the plurality of chutes.

18. The method of claim 17, wherein connecting the dish to the storage container comprises inserting a bottom of the storage container into a recess on a top of a boss that protrudes upwardly from the bottom wall of the dish.

19. The method of claim 18 further comprising positioning the storage container on the dish such that an inner cavity of the storage container is in communication with the trough via a connecting groove.

20. The method of claim 17, wherein connecting the dish to the storage container comprises connecting a bottom of the storage container to the bottom wall of the dish, wherein the bottom wall of the dish is provided with a conical protrusion that protrudes upwards, wherein the bottom of the storage container covers the conical protrusion and includes a plurality of notches arranged at intervals along a circumference of the storage container, and wherein an inner cavity of the storage container is communicated with the trough through the plurality of notches.
